(19) United States
(12) Patent Application Publication
(10) Pub. No.: US 2010/0319486 A1
(43) Pub. Date: Dec. 23, 2010

(54) TRANSMISSION

(75) Inventors: Masaki KAWAMOTO, Okazaki-shi (JP); Norio Kayukawa, Kounan-shi (JP); Takuya Yoshimi, Nishio-shi (JP); Toshiya Uematsu, Kariya-shi (JP); Hiroyuki Kato, Kariya-shi (JP); Shiro Ogami, Kariya-shi (JP); Yuichi Fukuhara, Toyoake-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Aisin Al Co., Ltd., Nishio-shi (JP)

(21) Appl. No.: 12/793,222

(22) Filed: Jun. 3, 2010

(30) Foreign Application Priority Data
Jun. 23, 2009 (JP) 2009-148277

(51) Int. Cl. F16H 37/06; F16H 57/04

(52) U.S. Cl. 74/665 L; 74/467

(57) ABSTRACT

A transmission for a vehicle is provided with a plurality of gears supported on shaft members rotatably supported in a case to extend in an axial direction, first and second large-diameter gears soaked at lower parts thereof in lubrication oil stored in a lubrication oil storage region formed at a lower portion of the case for scooping upward lubrication oil during rotations, and first and second receivers arranged to extend in the axial direction of the shaft members for collecting the upwardly scooped lubrication oils to supply the same to parts to be lubricated. The first and large-diameter gears are arranged respectively on one and the other end sides of the plurality of gears in the axial direction. Other gears of the plurality of gears except for the first and second large-diameter gears are formed to diameters that hardly agitate the lubrication oil in the lubrication oil storage region.

### INCORPORATION BY REFERENCE

This application is based on and claims priority under 35 U.S.C. 119 with respect to Japanese patent application No. 2009-148277 filed on Jun. 23, 2009, the entire content of which is incorporated herein by reference.

### BACKGROUND OF THE INVENTION

1. Field of the Invention

The present invention relates to a transmission capable of performing lubrication by scooping up lubrication oil by speed change gears.

Discussion of the Related Art

Heretofore, as vehicle transmissions for adjusting the driving power of an internal combustion engine and the vehicle speed, there has been known one which performs lubrication by scooping up lubrication oil by speed change gears. For example, in one shown in JP 2001-254811 A, all of speed change gears provided on an output shaft 12 are soaked in lubrication oil stored at a lower part of a transmission case 14. Then, with rotation of the output shaft 12, the respective speed change gears are lubricated at their toothed surfaces and scoop up lubrication oil to accumulate the lubrication oil in a gutter-like oil receiver which is arranged over the speed change gears to open upward, and the lubrication oil is supplied to the interiors of various shafts by being flown along flow passages of the oil receiver.

However, in the vehicle transmission shown in the aforementioned Japanese application, since all of the speed change gears provided on the output shaft 12 are soaked in the lubrication oil, the resistance which the respective speed change gears suffer in agitating the lubrication oil during rotation of the output shaft 12 becomes very large and hence, would cause a loss in the driving power from the transmission to be adversely affected on the driving and fuel efficiency of the vehicle.

### SUMMARY OF THE INVENTION

It is therefore an object of the present invention to provide an improved transmission with a lubrication structure which is capable of being little in power loss and capable of efficiently supplying scooped lubrication oil to various parts to be lubricated.

Briefly, according to the present invention, there is provided an improved transmission which comprises a case; at least one shaft member rotatably supported in the case to extend in an axial direction; a plurality of gears rotatably supported on the at least one shaft member and rotationally connectable by shift clutches with the at least one shaft member; first and second large-diameter gears included in the plurality of gears and soaked at lower parts thereof in lubrication oil stored in a lubrication oil storage region which is formed at a lower portion in the case, for scooping upward the lubrication oil during rotations; and first and second receivers arranged to extend in the axial direction of the at least one shaft member for respectively collecting lubrication oils scooped upward by the first and second large-diameter gears and for supplying the collected lubrication oils toward parts to be lubricated. The first and the second large-diameter gears are arranged respectively on one end side and the other end side in the axial direction of the plurality of gears, and the gears except for the first and second large-diameter gears are formed to have respective diameters which hardly agitate the lubrication oil stored in the lubrication oil storage region.

With this construction, the first and second large-diameter gears are arranged respectively at axial opposite ends of the plurality of gears. The first and second large-diameter gears are soaked at the lower parts thereof in the lubrication oil in the lubrication oil storage region and operate to scoop up the lubrication oil during rotations. The lubrication oils scooped up by the first and second large-diameter gears are respectively collected by the first and second receivers and are supplied to the respective parts to be lubricated to effect the lubrication thereat. In this way, the scooping the lubrication oil is performed by each of the two large-diameter gears, whereas other gears except for the first and second large-diameter gears hardly agitate the lubrication oil in the lubrication oil storage region. Thus, the total resistance acting on the plurality of gears during agitation of the lubrication oil can be decreased, so that the power transmitting efficiency of the transmission can be enhanced. Further, since the two large-diameter gears only are required to be partly soaked in the lubrication oil in lubrication oil storage region, the quantity of the lubrication oil stored in the lubrication oil storage region can be reduced, so that the reductions in cost as well as weight can be realized.

### BRIEF DESCRIPTION OF THE DRAWINGS

The foregoing and other objects and many of the attendant advantages of the present invention may readily be appreciated as the same becomes better understood by reference to the preferred embodiments of the present invention when considered in connection with the accompanying drawings, wherein like reference numerals designate the same or corresponding parts throughout several views, and in which:

FIG. 1 is a view showing the schematic construction of a transmission 1 in a first embodiment as viewed in the axial or longitudinal direction, wherein the cross-sections of a collecting portion 92a of a first receiver 92 and a collecting portion 94a of a second receiver 94 are shown together with gear parts;

FIG. 2 is a schematic view of the transmission as viewed in the direction A in FIG. 1, wherein a mission case 11 and a clutch housing 12 of a case 10 are shown in section and wherein sliding parts and lubrication oil stored in the case are schematically shown;

FIG. 3 is a skeletal figure showing the entire structure of the transmission 1;

FIG. 4 is a view showing the schematic construction of a transmission 111 in a second embodiment as viewed in the longitudinal direction, wherein the cross-sections of a collecting portion 192a of a first receiver 192 and a collecting portion 194a of a second receiver 194 are shown together with gear parts;

FIG. 5 is a schematic view of the transmission as viewed in the direction B in FIG. 4, wherein the mission case 11 and the clutch housing 12 of the case 10 are shown in section and wherein the sliding parts and lubrication oil stored in the case are schematically shown; and

FIG. 6 is a skeletal figure showing the entire structure of a transmission 211 in a third embodiment, wherein a first receiver 241, a second receiver 246 and the flows of lubrication oil are shown schematically.

### DETAILED DESCRIPTION OF THE PREFERRED EMBODIMENTS

### First Embodiment

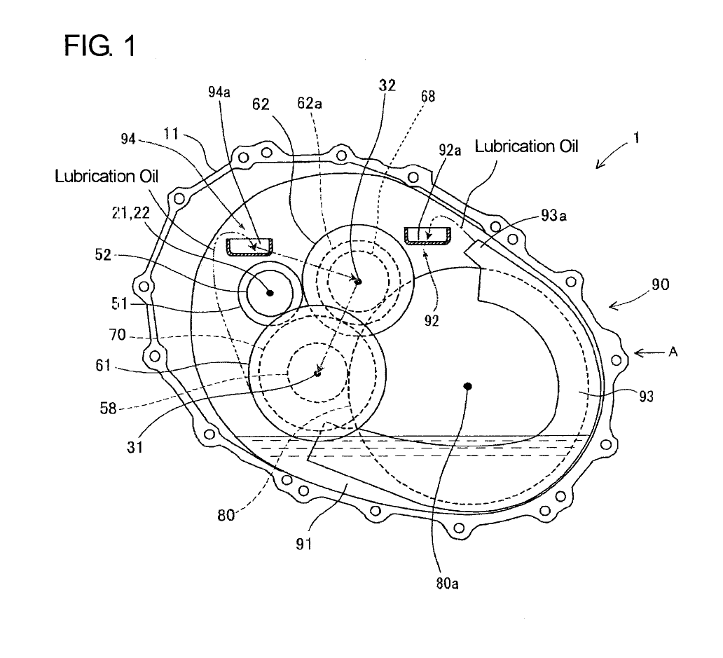

Hereafter, a transmission 1 for a vehicle in a first embodiment to which the present invention is embodied will be described with reference to FIGS. 1 to 3. As shown in FIGS. 1 to 3, the transmission 1 is a dual-clutch automatic transmission with seven forward speeds and is provided with a first input shaft 21, a second input shaft 22, a first output shaft 31 and a second output shaft 32 as shaft members to extend in the axial direction in a case 10. Further, in the case 10, there are provided a dual clutch 40, drive gears 51-57 (corresponding to “drive gears” in the claimed invention) for respective speed change stages, final reduction drive gears 58, 68, driven gears 61-67 for the respective speed change stages, a reverse gear 70, a ring gear 80 (corresponding to the “first large-diameter gear” in the claimed invention), a first lubrication mechanism 90 and a second lubrication mechanism 100. The final reduction drive gears 58, 68, the driven gears 61-67 and the reverse gear 70 correspond to “driven gears” in the claimed invention, and a first-speed driven gear 61 corresponds to the “second large-diameter gear” in the claimed invention.

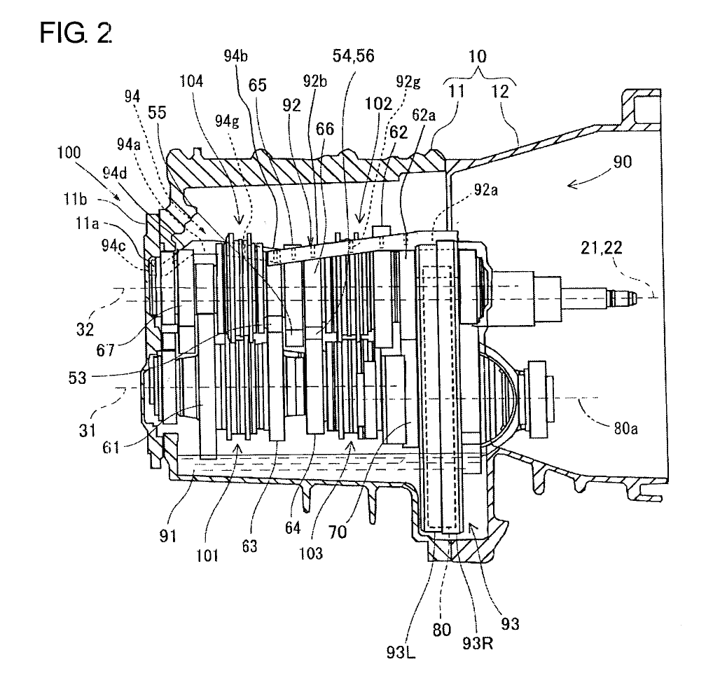

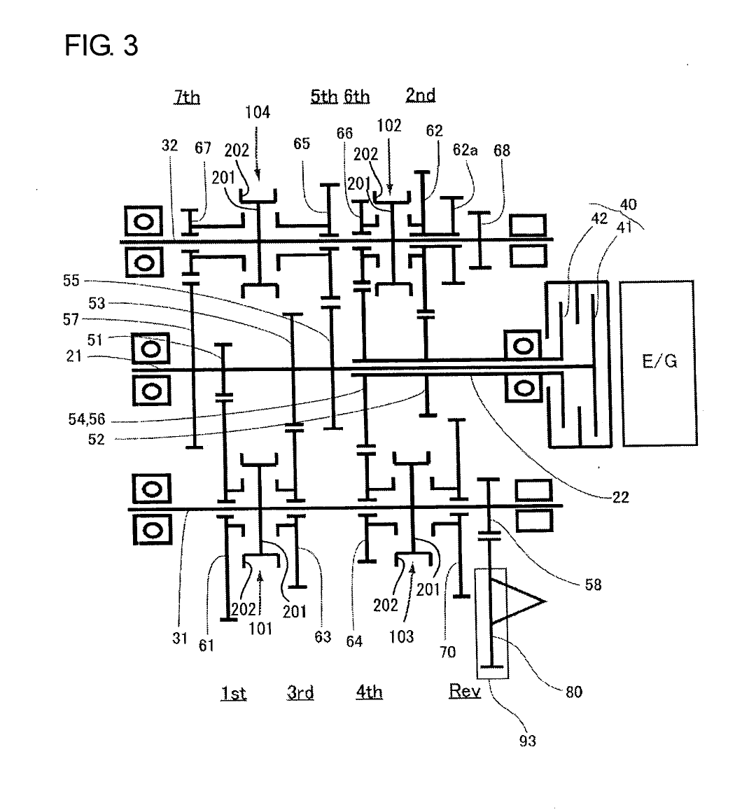

As shown in FIG. 2, the case 10 comprises a mission case 11 and a clutch housing 12. The mission case 11 rotatably supports the respective shafts 21, 22, 31, 32 by a plurality of bearings (shown in FIG. 3 only without reference numerals) and stores lubrication oil used for lubricating various parts to be lubricated including the aforementioned plurality of gears and the like. The clutch housing 12 has an end surface in contact with a mating end surface of the mission case 11 and is secured to the mission case 11 by means of bolts (not shown). The clutch housing 12 rotatably supports the respective shafts through a plurality of bearings (shown in FIG. 3 only without reference numerals) and contains the dual clutch 40 therein.

The first input shaft 21 takes a hollow shaft-like shape and is supported by the bearings to be rotatable relative to the mission case 11. Bearing support portions and a plurality of external splines are formed on the outer surface of the first input shaft 21. A first-speed drive gear 51 and a third-speed drive gear 53 are formed directly on the first input shaft 21. A fifth-speed drive gear 55 and a seventh-speed drive gear 57 are press-fitted on the external splines formed on the outer surface of the first input shaft 21. Further, the first input shaft 21 has formed thereon a coupling portion connectable with a first clutch 41 of the dual clutch 40.

The second input shaft 22 takes a hollow shaft-like shape, is rotatably supported on the outer surface of a part of the first input shaft 21 through a plurality of bearings (not shown) and is rotatably supported by a bearing (shown in FIG. 3 without reference numeral) relative to the clutch housing 12. That is, the second input shaft 22 is arranged to be coaxial with, and rotatable relative to, the first input shaft 21. Like the first input shaft 21, the second input shaft 22 has bearing support portions and a plurality of external gears formed on the outer surface thereof. That is, the second input shaft 22 has formed thereon a second-speed drive gear 52 and large-diameter fourth-speed and sixth-speed drive gears 54, 56. Further, the second input shaft 22 has formed thereon a coupling portion connectable to a second clutch 42 of the dual clutch 40.

The first output shaft 31 is supported by the bearings (shown in FIG. 3 only without reference numerals) to be rotatable relative to the mission case 11 and the clutch housing 12 and is arranged in the mission case 11 in parallel to the first input shaft 21. On the outer surface of the first output shaft 31, the final reduction drive gear 58 is formed, and bearing support portions and a plurality of external splines are formed. Respective hubs 201 of shift clutches 101, 103 are press-fitted on the external splines of the first output shaft 31 through spline fittings. The final reduction drive gear 58 is in mesh with the ring gear 80 as the first large-diameter gear of a differential gear.

Of the gears arranged in the mission case 11, the ring gear 80 is arranged on an internal combustion engine E/G side (corresponding to “one end side” in the claimed invention) in the axial direction. Further, the first output shaft 31 has formed thereon the first-speed driven gear 61 as the second large-diameter gear, a third-speed driven gear 63, a fourth-speed driven gear 64 and a support portion for supporting the reverse gear 70. Of the gears arranged in the mission case 11, the first-speed driven gear 61 is arranged on a side (corresponding to “the other end side” in the claimed invention) opposite to the internal combustion engine E/G side in the axial direction.

The first-speed driven gear 61 meshes with the first-speed drive gear 51 formed on the first input shaft 21 and is rotated continuously while the first input shaft 21 is rotated. Further, the first-speed driven gear 61 is so supported that while the first input shaft 21 is not rotated, the first-speed driven gear 61 is rotated to follow, with slips or slides, the rotation of the first output shaft 31 rotated together with the final reduction drive gear 58 which is rotated continuously during travelling. That is, the first-speed driven gear 61 is rotated continuously during the travelling of the vehicle. Further, the first-speed driven gear 61 is larger in diameter than other gears except for the ring gear 80. The first-speed driven gear 61 is soaked at its lower part in the lubrication oil stored at the bottom portion of the mission case 11 and is able to scoop up the lubrication oil continuously.

The second output shaft 32 is supported by the bearings (shown in FIG. 3 only without reference numerals) to be rotatable relative to the mission case 11 and the clutch housing 12 and is arranged in the mission case 11 in parallel to the first input shaft 21. Further, like the first output shaft 31, the second output shaft 32 has the final reduction drive gear 68 formed on the outer surface thereof and also has bearing support portions and a plurality of external splines formed on the outer surface thereof. Respective hubs 201 of shift clutches 102, 104 are press-fitted on the external splines of the second output shaft 32 through spline fittings. The final reduction drive gear 68 is in mesh with the ring gear 80 of the differential gear. Further, the second output shaft 32 has support portions formed thereon which respectively support a second-speed driven gear 62, a fifth-speed driven gear 65, a sixth-speed driven gear 66 and a seventh-speed driven gear 67 to be able to idle.

As shown in FIG. 3, the dual clutch 40 comprises the first clutch 41 for transmitting the rotational driving power of the internal combustion engine E/G (corresponding to the “prime mover” in the claimed invention) to the first input shaft 21 and the second clutch 42 for transmitting the rotational driving power of the internal combustion engine E/G to the second input shaft 22. The dual clutch 40 is contained in the clutch housing 12 on the right side as viewed in FIG. 2 and is provided in axial alignment with the first input shaft 21 and the second input shaft 22. The first clutch 41 is connectable to a coupling shaft portion of the first input shaft 21, while the second clutch 42 is connectable to a coupling shaft portion of the second input shaft 22. Thus, a high speed shift change is possible by selectively operating the first and second clutches 41, 42 relative to the first and input shafts 21, 22 in response to a vehicle control command to switch the connection with the internal combustion engine E/G.

The reverse gear 70 is provided to be able to idle on a support portion which is formed on the first output shaft 31 for the reverse gear 70. Further, in the present embodiment, the reverse gear 70 always meshes with a small-diameter gear 62a which is formed bodily with the second-speed driven gear 62.

Each of the shift clutches 101-104 is provided with a hub 201 and a sleeve 202. Each hub 201 takes a shape of a hollow disc with an internal spline and an external spline and is press-fitted on the external spline of the first output shaft 31 or the second output shaft 32 through spline fitting. Each sleeve 202 meshes with the external spline of each hub 201 to be slidable relative to each hub 201 and, when slidden, is brought into meshing with a synchromesh gear portion of an associated one of the driven gears 61-67 for the respective speed change stages and the reverse gear 70. That is, the sleeves 202 have functions to selectively switch the meshing states and the non-meshing states with the synchromesh gears (not shown), provided on the driven gears 61-67 for the speed change stages and the reverse gear 70, by being axially slidden and to selectively couple the driven gears 61-67 and the reverse gear 70 with the first output shaft 31 and the second output shaft 32.

As best shown in FIG. 1, the ring gear 80 is in mesh with the final reduction drive gears 58, 68 and thus, is always in driving connection with the first and second output shafts 31, 32. Further, the ring gear 80 is larger in diameter and also larger in the number of teeth than the final reduction drive gears 58, 68. The ring gear 80 is connected to driving road wheels (not shown) through a rotational shaft 80a as shaft member supported in the case 10 and the differential gear (not shown). That is, the ring gear 80 of the differential gear is a gear which is constituted as a final gear in the transmission 1 to be rotated continuously during the traveling of the vehicle. Further, the ring gear 80 is located at a lower position than the remaining other gears. Thus, a lower part of the ring gear 80 is soaked in the lubrication oil stored at the bottom portion of the mission case 11 and is always able to scoop up the lubrication oil. In this way, the ring gear 80 and the first-speed driven gear 61 being respectively first and second large-diameter gears are held soaked partly in the lubrication oil within a lubrication oil storage region 91. On the other hand, on the first output shaft 31, those other gears 63, 64, 70, 58 except for the ring gear 80 and the first-speed driven gear 61 are provided to be small in diameter so that they are not soaked in the lubrication oil within the lubrication oil storage region 91. If hardly agitating the lubrication oil, those other gears 63, 64, 70, 58 except for the ring gear 80 and the first-speed driven gear 61 being respectively first and second large-diameter gears may be selected to outer diameters that allow parts of the outer circumferences thereof to be slightly soaked in the lubrication oil.

As shown in FIG. 1, a separator 93 takes the form of an arc as viewed in the axial direction of the transmission 1 and is formed to surround a circumferential part, covering the lubrication oil storage region 91 and a circumferentially one or upper side beyond the same, of the whole circumference of the ring gear 80. The separator 93 partitions the part surrounded by the separator 93 of the lubrication oil storage region 91 from the remaining part of the same and serves to stabilize the quantity and splashing direction of the lubrication oil scooped up by the rotation of the ring gear 80 by surrounding the circumferential part of the ring gear 80. The separator 93 is formed to have a generally U-letter section taken longitudinally which is analogous to the longitudinal section of the circumferential part of the ring gear 80.

Further, in the present embodiment, as best shown in FIG. 2, the separator 93 is constituted to take the generally U-letter section by overlapping two left-right separable side members 93L, 93R, each taking an L-letter shape in longitudinal section, at bottom portions thereof. The left side member 93L is secured to the mission case 1 by means of bolts (not shown). Likewise, the right side member 93R of the separator 93 is secured to the clutch housing 12 by means of bolts (not shown). The separator 93 is assembled in such a way that when the clutch housing 12 is secured to the mission case 11 by bolt-fastening, the two side members 93L, 93R come close to opposite side surfaces of the ring gear 80 and face the outer surface of the same at bottom parts thereof. Further, a lower part of the separator 93 reside in the lubrication oil storage region 91. Thus, the lower part of the separator 93 partitions the lubrication oil stored around the circumferential part of the ring gear 80 from the remainder of the lubrication oil stored in the mission case 11. This advantageously sets the quantity of lubrication oil agitated by the ring gear 80 being in rotation. In a modification, the separator 93 may not be provided. Where the separator 93 is not provided, differences are made in the quantity and the splashing direction and spread of the lubrication oil scooped up by the rotation of the ring gear 80. In this modified case, the position at which a first receiver 92 referred to later is arranged may be altered in dependence on the splashing state of the scooped-up lubrication oil.

The first lubrication mechanism 90 includes the lubrication oil storage region 91 and the first receiver 92. As shown in FIGS. 1 and 2, the lubrication oil storage region 91 is a region which stores lubrication oil at the bottom portion of the mission case 11. The height of the lubrication oil storage region 91 from the bottom portion of the mission case 11 is set so that the lower parts of the ring gear 80 and the first-speed driven gear 61 are soaked in the lubrication oil. In other words, those other gears 63, 64, 70 except for the ring gear 80 and the first-speed driven gear 61 are not soaked in the lubrication oil stored in the lubrication oil storage region 91. Where parts of the outer circumferences of the gears 63, 64, 70 except for the ring gear 80 and the first-speed driven gear 61 are slightly soaked in the lubrication oil in the lubrication oil storage region 91, the outer diameters of the gears 63, 64, 70 may be designed to those diameters that hardly agitate the lubrication oil in the lubrication oil storage region 91.

The lubrication oil storage region 91 enables the stored lubrication oil to be scooped up by the rotation of the ring gear 80 over the ring gear 80. The lubrication oil scooped up by the ring gear 80 splashes over the ring gear 80 and is collected by the first receiver 92. Further, the lubrication oil storage region 91 also enables the stored lubrication oil to be scooped up by the rotation of the first-speed driven gear 61 over the first-speed driven gear 61. The lubrication oil scooped up by the first-speed driven gear 61 splashes around over the first-speed driven gear 61 and is collected by a second receiver 94.

The first receiver 92 is a member which is separate from the clutch housing 12 and which is secured by bolt fastening to an upper part of the clutch housing 12. As shown in FIG. 2, the first receiver 92 has a collecting portion 92a which is provided on the internal combustion engine E/G side in the axial direction (longitudinal direction) for receiving (collecting) the splashing lubrication oil. The first receiver 92 also has a flow channel 92b for leading the collected lubrication oil to supply the same toward toothed surfaces of the gears 62a, 62, 66, 65 and the shift clutches 102, 103 being respective parts to be lubricated which are arranged in the vicinity of the ring gears 80 in the axial direction.

Each of the collecting portion 92a and the flow channel 92b takes a gutter shape of a U-letter in cross-section orthogonal to the axis of the ring gear 80 to open an upper part thereof. The collecting portion 92a is a part for collecting the lubrication oil which splashes by being scooped up by the rotation of the ring gear 80, and is placed at a position shown in FIG. 1 toward which the most part of the splashing lubrication oil falls. The position is over the ring gear 80 and is almost in the direction tangential to the outer circumference of the ring gear 80.

In order that an adequate quantity of lubrication oil flows down or drops on each of the respective parts to be lubricated such as the toothed surfaces of the gears 62a, 62, 66, 65, the shift clutches 102, 103 and the like, the flow channel 92b is provided with a plurality of flow-down ports 92g (FIG. 2) at respective positions thereof which reside over the respective parts to be lubricated. From the point of view of reliably supplying lubrication oil from those positions right over the respective parts to be lubricated, the flow channel 92b is not limited to being linear in shape and instead, may take a shape deformed or curved to correspond to the positions of the respective parts to be lubricated.

The first receiver 92 is arranged in the axial direction from a start point on the internal combustion engine E/G side toward the opposite side to the internal combustion engine E/G side as it is downwardly inclined at a predetermined angle and extends to a predetermined position. The predetermined position expressed herein means a position sufficient to lubricate the respective parts to be lubricated with the lubrication oil which is collected in the collecting portion 92a of the first receiver 92 as a result of being scooped up by the ring gear 80. In other words, where much quantity of lubrication oil is collected in the collecting portion 92a, the first receiver 92 can be long to lubricate many parts to be lubricated. Where a little quantity of lubrication oil is collected, on the contrary, the first receiver 92 is set to be short. The differences depend on types of transmissions, and the length of the first receiver 92 is determined in dependence on a transmission used. Accordingly, if the first receiver 92 can collect a sufficient quantity of lubrication oil, the first receiver 92 may be extended to the neighborhood of the first-speed driven gear 61 which is arranged on the opposite side to the internal combustion engine E/G side in the axial direction, in order to lubricate the gears 53, 67 and the shift clutches 101, 104 and the like arranged in the vicinity of the first-speed driven gear 61.

The second lubrication mechanism 100 includes the lubrication oil storage region 91 common to the first lubrication mechanism 90 and the second receiver 94. As mentioned earlier, the lubrication oil storage region 91 enables the stored lubrication oil to be scooped up by the rotation of the first-speed driven gear 61 over the first-speed driven gear 61. The lubrication oil scooped up by the first-speed driven gear 61 splashes over first-speed driven gear 61 and is collected by the second receiver 94.

The second receiver 94 is a member which is separate from the mission case 11 and which is secured by bolt fastening to the mission case 11. As shown in FIG. 2, the second receiver 94 has a collecting portion 94a which is provided above the first-speed driven gear 61 for receiving (collecting) the splashing lubrication oil. The second receiver 94 also has a flow channel 94b for leading the collected lubrication oil to supply the same toward toothed surfaces of the gears 53, 57 and the shift clutches 101, 104 being respective parts to be lubricated which are arranged in the vicinity of the first-speed driven gear 61 in the axial direction. Further, the second receiver 94 also has another flow channel 94d for leading the collected lubrication oil toward the side opposite to the flow channel 94b with the collecting portion 94a therebetween, to supply the lubrication oil toward the interiors and the like of the output shafts 31, 32. A lower end portion of the flow channel 94d has a supply port 94c for supplying the lubrication oil toward the interiors of the output shafts 31, 32. That is, the flow channel 94b and the flow channel 94d extend downwardly respectively toward opposite sides from a center point over the first-speed driven gear 61 in the axial direction and collectively take a generally inverted V-letter shape in the side view.

The collecting portions 94a is a part for collecting the lubrication oil which splashes by being scooped up by the rotation of the first-speed driven gear 61, and is placed at a position shown in FIG. 1 which is partly over the first-speed driven gear 61 and toward which the most part of the splashing lubrication oil falls. The position is partly over the first-speed driven gear 61 and is almost in the direction tangential to the outer circumference of the first-speed driven gear 61. Each of the collecting portion 94a and the flow channels 94b, 94d takes a gutter shape of a U-letter in cross-section orthogonal to the axis of the first-speed driven gear 61 to open an upper part thereof.

The flow channel 94b is a flow channel for lubricating the toothed surfaces of the gears 53, 57 and the shift clutches 101, 104 which are not lubricated by the first receiver 92, and therefore, extends to a position in the axial direction where it comes close to or partly overlaps a lower end portion of the flow channel 92b of the first receiver 92. Accordingly, the flow channel 94b may not be provided (i.e., may be omitted) if the first receiver 92 extends to the neighborhood of the first-speed driven gear 61 and hence, is able to sufficiently lubricate the toothed surfaces of the gears 53, 57 and the shift clutches 101, 104 which are arranged in the vicinity of the first-speed driven gear 61.

In order that an adequate quantity of lubrication oil is supplied to flow down or drop on each of the respective parts to be lubricated such as the toothed surfaces of the gears 53, 57, the shift clutches 101, 104 and the like, the flow channel 94b is also provided with a plurality of flow-down ports 94g (FIG. 2) at respective positions thereof which reside over the respective parts to be lubricated. From the point of view of reliably supplying lubrication oil from those positions just over the respective parts to be lubricated, like the flow channel 92b, the flow channel 94b is not limited to being linear in shape and instead, may take a shape deformed or curved to correspond to the positions of the respective parts to be lubricated.

The supply port 94c is formed at the lower end of the flow channel 94d and is inserted into a transverse hole (not shown) which is in fluid communication with inflow grooves 11a formed on a cover 11b of the mission case 11. The second receiver 94 leads lubrication oil from the supply port 94c to the transverse hole communicating with the inflow grooves 11a to supply the lubrication oil to a through hole formed in the second output shaft 32 through one of the inflow grooves 11a. The second receiver 94 also supplies the lubrication oil to a through hole formed in the first output shaft 31 through the other inflow groove 11a. The inflow grooves 11a are oil channels or passages for leading the lubrication oils into the through holes of the output shafts 31, 32 or the like and is provided on the cover 11 b closing the end opening of the mission case 11, the opening being axially on the side at which the second receiver 94 is arranged and which is opposite to the internal combustion engine E/G side.

Next, description will be made regarding the operation of the embodiment as constructed above. When the transmission 1 is started, a controller (not shown) for the automatic gear transmission 1 in the present embodiment selectively operates the first and second clutches 41, 42 of the dual clutch 40 and the respective shift clutches 101-104 in dependence on the operating conditions of the vehicle such as throttle opening, engine rotational speed, vehicle speed and the like. In the state of being out of operation, both of the first and second clutches 41, 42 of the dual clutch 40 are in disconnection, and each of the shift clutches 101-104 are at a neutral position thereof.

When in the state of the vehicle stopped, the internal combustion engine E/G is started and a shift lever (not shown) of the gear transmission 1 is moved to a forward position, the controller slides the sleeve 202 of the shift clutch 101 to bring the sleeve 202 into meshing with a synchromesh gear portion of the first-speed driven gear 61 for the speed change stages and holds other shift clutches 102-104 at the neutral positions, whereby the first-speed stage is set. If the rotational speed of the internal combustion engine E/G exceeds a predetermined low rotational speed as the throttle opening increases, the controller gradually increases the engaging power of the first clutch 41 of the dual clutch 40 in adaptation for the throttle opening, and thus, the driving torque is transmitted from the first clutch 41 to the ring gear 80 of the differential gear through the first input shaft 21, the first-speed gears 51, 61, the shift clutch 101, the first output shaft 31 and the final reduction drive gear 58, whereby the vehicle begins to travel at the first speed.

When the operating state of the vehicle becomes a state suitable for the second-speed traveling with an increase in the throttle opening or the like, the controller first sets the second-speed stage by sliding the sleeve 202 of the shift clutch 102 to bring the sleeve 202 into meshing with a synchomesh gear portion of the driven gear 62 for the speed change stages, then switches the travelling stage to the second-speed travelling by switching the duel clutch 40 to the second clutch 42 side and then, releases the sleeve 202 of the shift clutch 101. Thus, the driving torque is transmitted from the second clutch 42 to the ring gear 80 of the differential gear through the second input shaft 32, the second-speed gears 52, 62, the shift clutch 102, the second output shaft 32 and the final reduction drive gear 68, whereby the vehicle travels at the second speed.

At this time, the first-speed driven gear 61 meshing with the first-drive gear 51 formed on the first input shaft 21 is held in a neutral state as a result that the rotation of the first input shaft 21 is stopped and that the shift clutch 101 is operated to be disengaged or released. However, the first output shaft 31 rotatably supporting the first-speed driven gear 61 remains to be continuously rotated with the rotation of the final reduction drive gear 58 which is continuously rotated together with the ring gear 80. Thus, the support portion for the first-speed driven gear 61 is rotated, whereby the first-speed driven gear 61 supported on the support portion is rotated to follow the support portion due to the friction force with the same.

In a similar manner, for each of the third through seventh speeds, the controller successively selects the speed change stages in dependence on the operating state of the vehicle and alternately selects the first clutch 41 and the second clutch 42, whereby the travelling at a speed change stage suitable to the state can be performed.

During each of the third-speed stage, the fifth-speed stage and the seventh-speed stage wherein the speed change stage is set with the first input shaft 21 coupled to the first clutch 41, the first-speed driven gear 61 is rotated continuously because it is always in rotational connection with the first-speed drive gear 51 formed on the first input shaft 21. Further, during each of the fourth-speed stage and the sixth-speed stage wherein the speed change stage is set with the second input shaft 22 coupled to the second clutch 42, the first-speed driven gear 61 is rotated to follow the support portion provided on the first output shaft 31 rotated with the rotation of the final reduction drive gear 58 which is continuously rotated as is the case of being at the second-speed stage. For this reason, the first-speed driven gear 61 and the ring gear 80 are maintained to be continuously rotated during the travelling of the vehicle.

When the shift lever of the gear transmission 1 is shifted to the reverse position in the state that the vehicle is stopped with the internal combustion engine E/G remaining in operation, the controller detects the shift operation and slides the sleeve 202 of the shaft clutch 103 to bring the sleeve 202 into meshing with a synchromesh gear portion of the reverse gear 70 and holds each of the other shift clutches 101, 102, 104 at the neutral position, whereby the reverse stage is set. The reverse gear 70 is always in mesh with the small-diameter gear 62a which is formed bodily with the driven gear 62 for the speed change stage. Thus, the driving torque is transmitted from the second clutch 42 to the ring gear 80 of the differential gear through the second input shaft 22, the second-speed gears 52, 62, 62a, the reverse gear 70 and the shift clutch 103, the first output shaft 31 and the final reduction drive gear 58, whereby the vehicle starts the reverse movement.

Next, the operation of the first lubrication mechanism 90 will be described. As mentioned earlier, during the forward movement wherein lubrication is particularly required inside the transmission 1 of the vehicle, the ring gear 80 of the differential gear is kept to be continuously rotated through the final reduction drive gear 58 or 68 of the transmission 1. Therefore, lubrication oil is continuously scooped up from the lubrication oil storage region 91 constituting the lubrication mechanism 90 which stores the lubrication oil at the bottom portion of the mission case 11. The lubrication oil scooped up by the rotation of the ring gear 80 splashes in the tangential direction of the outer circumference of the ring gear 80. The separator 93 is formed to surround the circumferential part of the ring gear 80 which part extends from the lubrication oil storage region 91 to the circumferential outer or upper part of the same, of the whole outer circumference of the ring gear 80. With this arrangement, the most quantity of the scooped-up lubrication oil splashes in the direction in which the upper end portion 93a of the separator 93 is opened, namely, in the direction toward the location of the first receiver 92.

The first receiver 92 takes the shape of a gutter opening upward. Of the lubrication oil so splashed, a predetermined (i.e., large) rate in quantity of the lubrication oil falls in the collecting portion 92a, having the gutter-shape interior, to be collected. Then, the lubrication oil collected in the collecting portion 92a flows down along the flow channel 92b due to its gravity, and an appropriate quantity of the lubrication oil flows down or drops from each of the flow-down ports 92g provided at right places over the parts to be lubricated such as the toothed surfaces of the gears 62a, 62, 66, 65 and the shift clutches 102, 103 to perform the lubrication thereof. It is to be noted that when the gears 62a, 62, 66, 65 are lubricated, the gears 70, 52, 54, 56, 64, 55 meshing directly or indirectly therewith are also lubricated through transfers of the lubrication oils therebetween. It is also to be noted that the gears 58, 68 meshing with the ring gear 80 are lubricated with the lubrication oil adhered to the ring gear 80 acting as an oil scoop-up gear.

Next, the operation of the second lubrication mechanism 100 will be described. As mentioned before, the first-speed driven gear 61 being the second large-diameter gear is also a gear which like the ring gear 80, is continuously rotated during the travelling of the vehicle. Therefore, lubrication oil is continuously scooped up from the lubrication oil storage region 91 constituting the second lubrication mechanism 100 which stores the lubrication oil at the bottom portion of the mission case 11. The lubrication oil scooped up by the rotation of the first-speed driven gear 61 splashes in the tangential direction of the outer circumference of the first-speed driven gear 61. Thus, of the splashed lubrication oil, a predetermined (i.e., large) rate in quantity of the lubrication oil is splashed in the direction toward the location of the second receiver 94. The second receiver 94 takes the shape of a gutter opening upward. Therefore, of the splashed lubrication oil, the predetermined rate in quantity of the lubrication oil falls in the collecting portion 94a, having the gutter-shape interior, to be collected. Then, the lubrication oil collected in the collecting portion 94a flows down along the flow channel 94b due to its gravity, and an appropriate quantity of the lubrication oil flows down or drops from each of the flow-down ports 94g provided at right places over the parts to be lubricated such as the toothed surfaces of the gears 53, 57 and the shift clutches 101, 104 to perform the lubrication thereof. It is to be noted that when the gears 53, 57 are lubricated, the gears 63, 67 respectively meshing therewith are also lubricated through transfers of the lubrication oils therebetween. It is also to be noted that the gear 51 meshing with the first-speed driven gear 61 is lubricated with the lubrication oil adhered to the first-speed driven gear 61 acting as another oil scoop-up gear.

Further, in the second receiver 94, from the supply port 94c formed at the lower end portion of the flow channel 94d which is provided on the opposite side to the flow channel 94b with the collecting portion 94a therebetween, lubrication oil is supplied through the inflow grooves 11a into the through holes of the first output shaft 31 and the second output shaft 32, whereby sufficient lubrication are performed on the bearings (not shown) and the like constituting the support portions for the respective gears, through radial passages (not shown) communicating with the through holes and opening on the support portions.

As is clear from the foregoing description, in the first embodiment, although it is often the case in the transmission 1 being a dual-clutch automatic transmission that when one input shaft 21 (22) is coupled by the clutch 41 (42) to the internal combustion engine E/G, the other input shaft 22 (21) is not drivingly rotated, either one of the output shafts 31, 32 is drivingly rotated by either one of the input shafts 21, 22 during the travelling of the vehicle. In such a dual-clutch automatic transmission, the ring gear 80 of the differential gear which is always in driving connection with the first output shaft 31 and the second output shaft 32 is utilized as the first large-diameter gear for scooping up lubrication oil, so that lubrication oil is continuously scooped up during the travelling of the vehicle. Further, because of being chosen as the first-speed driven gear 61 which is supported on the first output gear 31 in driving connection with the first input shaft 21, the second large-diameter gear is drivingly rotated by the rotation of the first input shaft 21 and, while the first input shaft 21 is not rotated, is continuously rotated by the first output shaft 31 to follow the same thanks to the friction force therewith. Consequently, during the travelling of the vehicle, the lubrication oil is scooped up by the ring gear 80 and the first-speed driven gear 61, so that the lubrication capability of the transmission 1 can be enhanced.

Further, the ring gear 80 of the differential gear is constituted as a final gear which is large in reduction ratio in the transmission 1, and the first-speed driven gear 61 is also constituted as a gear which is large in reduction ratio. Thus, the agitation resistance acting on the ring gear 80 is transmitted to the internal combustion engine E/G being a prime mover through gears which have a reduction ratio depending on the shift position. Further, the agitation resistant acting on the first-speed driven gear 61 is transmitted to the internal combustion engine E/G through the first-speed drive gear 51. Therefore, the forces which the agitation resistances acting on the two large-diameter gears exert on the internal combustion engine E/G are small, so that it is possible to reduce the resistance against the engine driving power.

Further, in the first embodiment, the ring gear 80 and the first-speed driven gear 61 are respectively arranged on opposite sides of the plurality of gears in the axial direction. Then, the first-speed driven gear 61, except for the small-diameter gears 63, 64, 70, 58 of those gears supported on the first output shaft 31, and the ring gear 80 are soaked, as both being large-diameter gears, in the lubrication oil in the lubrication oil storage region 91. Thus, scooping the lubrication oil from the lubrication oil storage region 91 is carried out by each of the ring gear 80 and the first-speed driven gear 61. Then, the lubrication oils scooped up by the respective gears are collected respectively in the first and second receivers 92, 94 and are supplied to the respective parts to be lubricated to perform lubrication. In this way, because the two gears of the ring gear 80 and the first-speed driven gear 61 perform the scooping of the lubrication oil, but the remaining other gears on the center side than the ring gear 80 and the first-speed driven gear 61 hardly agitate the lubrication oil, the agitation resistance built by the lubrication oil can be decreased, so that the transmission efficiency can be improved. Further, since required is to soak the two large-diameter gears of the ring gear 80 and the first-speed driven gear 61 in lubrication oil, it is possible to decrease the quantity of the lubrication oil which should be stored in the lubrication oil storage region 91, and hence, it is possible to reduce the cost and the weight of the transmission 1.

Further, in the first embodiment, the lubrication oil collected by the first receiver 92 is supplied toward the toothed surfaces of the gears 62a, 62, 66, 65 and the shift clutches 102, 103 which, of the parts to be lubricated, are those arranged to be adjacent to the ring gear 80. Further, the lubrication oil collected by the second receiver 94 is supplied toward the toothed surfaces of the gears 53, 57 and the shift clutches 101, 104 which, of the parts to be lubricated, are those adjacent to the first-speed driven gear 61 and not lubricated by the first receiver 92, and is also supplied to the support portions for the respective gears through the interiors of the first and second output shafts 31, 32. Because the parts to be lubricated are shared by the two receivers of the first and second receivers 92, 94, it is possible to efficiently supply lubrication oil to almost all of the parts to be lubricated in a simplified construction.

### Second Embodiment

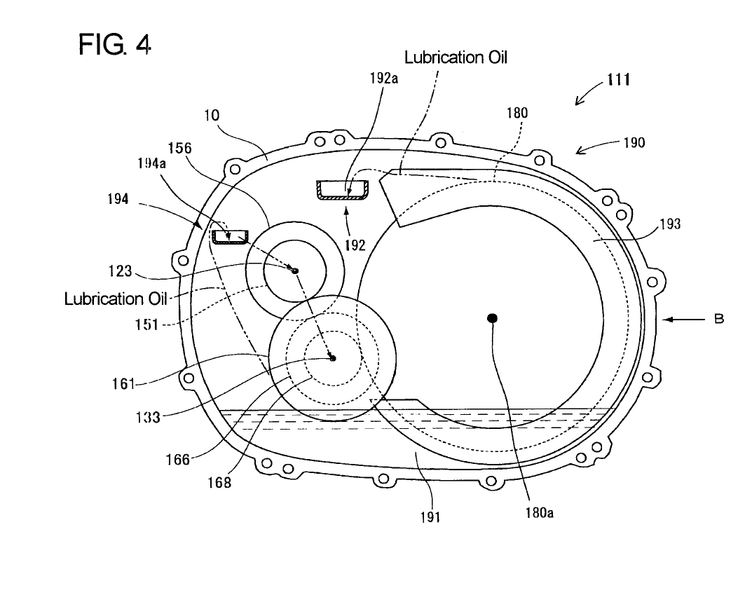

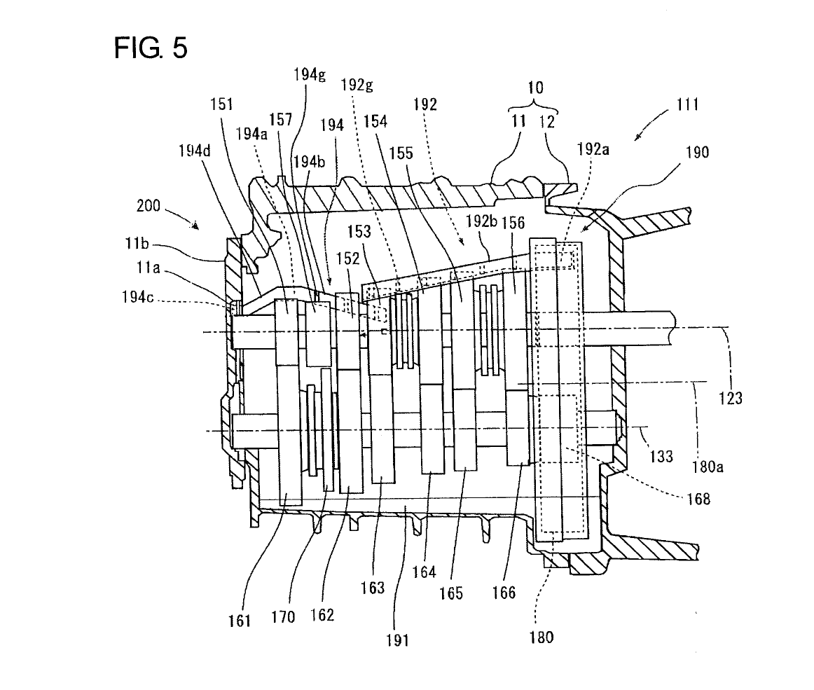

Next, a second embodiment will be described with reference to FIGS. 4 and 5. The construction of a transmission 111 in the second embodiment mainly differs in that the transmission 111 is a manual transmission though the transmission 1 in the first embodiment is a dual-clutch automatic transmission. In this connection, gears or the like of the transmission 111 differ in construction or arrangement from those of the transmission 1. Other constructions are the same as those in the first embodiment, and therefore, detailed description of the other constructions is omitted for the sake of brevity. Further, the operation of the manual transmission 111 is well known in the art, of which description is also omitted for the sake of brevity. Hereinafter, the differences only will be described.

As shown in FIGS. 4 and 5, the transmission 111 being a manual transmission is provided in the mission case 11 with an input shaft 123 and an output shaft 133 each being as shaft member as well as with drive gears 151-156 for respective speed change stages, driven gears 161-166 for respective speed change stages (of which a first-speed driven gear 161 corresponds to the “second large-diameter gear” in the claimed invention), a final reduction drive gear 168, a reverse gear 170, a ring gear 180 (corresponding to the “first large-diameter gear” in the claimed invention), and first and second lubrication mechanisms 190, 200. A separator 193 is provided for the ring gear 180.

As shown in FIG. 4, like the separator 93 in the foregoing first embodiment, the separator 193 takes the shape of an arc as viewed in the axial direction (longitudinal direction) of the transmission 111 and is formed to surround a circumferential part covering a lubrication oil storage region 191 and a circumferentially one or upper side beyond the same, of the whole outer circumference of the ring gear 180. In a modified form, as mentioned also in the first embodiment, the separator 193 may be omitted.

The input shaft 123 takes a shaft-like shape and is supported by bearings (not shown) to be rotatable relative to the mission case 11. A first-speed drive gear 151, a second-speed drive gear 152 and a small-diameter gear 157 which meshes with the reverse gear 170 through a counter gear (not shown) are directly formed on the outer surface of the input shaft 123. A plurality of support portions which support respective gears for idle rotations and a plurality of external splines are also formed on the outer surface of the input shaft 123. Hubs of input gear shift clutches are press-fitted on the external splines of the input shaft 123 through spline-fittings, and a third-speed drive gear 153 through a sixth-speed drive gear 156 are supported on the support portions to be able to idle. The input shaft 123 is connectable to a crankshaft of an internal combustion engine E/G through a clutch (all not shown) and takes the driving power from the internal combustion engine E/G into the transmission 111. That is, the input shaft 123 corresponds to the first input shaft 21 and the second input shaft 22 in the foregoing first embodiment. And, the input shaft 123 has a through hole formed therein for leading lubrication oil to lubricate the support portions being parts to be lubricated for the gears 153-156.

The output shaft 133 is supported by bearings (not shown) to be rotatable relative to the mission case 11 and the clutch housing 12 and is arranged in the mission case 11 in parallel to the input shaft 123. A third-speed driven gear 163 through a six-speed driven gear 166 and a final reduction drive gear 168 are directly formed on the outer surface of the output shaft 133. Further, support portions supporting gears 161, 162, 170 for idle rotations and a plurality of external splines are formed on the outer surface of the output shaft 133. Hubs of output gear shift clutches are press-fitted on the external splines of the output shaft 133, and the first-speed driven gear 161 being the second larger-diameter gear, the second-speed driven gear 162 and the reverse gear 170 are supported on the support portions to be able to idle. The first-speed driven gear 161 is arranged on the opposite side to the internal combustion engine E/G side (corresponding to “the other end side” in the claimed invention) in the axial direction. The first-speed driven gear 161 meshes with the first-speed drive gear 151 formed on the input shaft 123 and is always in rotational connection with the input shaft 123. Further, the first-speed driven gear 161 is larger in diameter than the remaining other gears except for the ring gear 180. The first-speed driven gear 161 is soaked at its lower part in the lubrication oil stored at the bottom portion of the mission case 11 and therefore, is able to continuously scoop up the lubrication oil.

While either one of the driven gears supported on the output shaft 133 is rotationally connected with either one of the drive gears supported on the input shaft 123, the output shaft 133 rotates the ring gear 180 of the differential gear through the final reduction drive gear 168 formed on the output shaft 133 and outputs a driving power from the transmission 111. The output shaft 133 corresponds to the first output shaft 31 and the second output shaft 32 in the foregoing first embodiment. Further, the output shaft 133 has a through hole formed therein in which lubrication oil flows. In the same manner as described in the foregoing first embodiment, lubrication oil flows through the inflow grooves 11a formed on the cover 11b which closes the opening portion opposite to the internal combustion engine E/G side in the axial direction of the mission case 11, and is supplied to the through holes of the input shaft 123 and the output shaft 133. Then, the support portions and the like as parts to be lubricated for the gears 153-156, 161, 162, 170 are lubricated with lubrication oils supplied from the through holes through radial passages (not shown) opening on the support portions and the like.

The ring gear 180 is always in rotational connection with the output shaft 133 through meshing with the final reduction drive gear 168. The ring gear 80 is larger in diameter and larger in the number of teeth than the final reduction drive gear 168. That is, the ring gear 180 of the differential gear is a gear which is arranged on the internal combustion engine E/G side (corresponding to “one end side” in the claimed invention) in the axial direction of the output shaft 133 and which as a final gear in the transmission 111, is continuously rotated during the travelling of the vehicle. The ring gear 180 has its lower part which is positioned lower than lower parts of any other gears. The ring gear 180 is soaked at its lower part in the lubrication oil stored in the bottom portion of the mission case 11 and therefore, is able to scoop up the lubrication oil. In this way, the lower parts of the ring gear 180 and the first-speed driven gear 161 respectively as the first and second large-diameter gears are soaked in the lubrication oil in the lubrication oil storage region 191. On the other hand, of those gears supported on the output shaft 133, the gears 162, 163, 164, 165, 166, 168 and 170 except for the first-speed driven gear 161 are formed to be small in diameter not to be soaked at any parts thereof in the lubrication oil stored in the bottom portion of the mission case 11. In a modified form, as mentioned in the foregoing first embodiment, the diameters of the gears 162, 163, 164, 165, 166, 168 and 170 except for the ring gear 180 and the first-speed driven gear 161 may be designed to such diameters that allow parts of those gears to be soaked slightly in the lubrication oil in the lubrication oil storage region 191 so that they hardly agitate the lubrication oil.

The first lubrication mechanism 190 is the same as the first lubrication mechanism 90 in the foregoing first embodiment and comprises the lubrication oil storage region 191 and a first receiver 192. As shown in FIG. 5, the first receiver 192 includes a collecting portion 192a (corresponding to the collecting portion 92a in the first embodiment) which is provided on the internal combustion engine E/G side in the axial direction for collecting lubrication oil, and a flow channel 192b (corresponding to the flow channel 92b in the first embodiment) for leading the collected lubrication oil toward respective parts to be lubricated.

The flow channel 192b extends in the axial direction and leads the lubrication oil scooped up by the ring gear 180 and collected in the collecting portion 192a to supply the lubrication oil to the respective parts to be lubricated. In order that lubrication oils of an appropriate quantity are supplied by being flown down or dropping toward the respective parts to be lubricated such as the toothed surfaces of the gears 153-156, the input and output shaft shift clutches (not shown) and the like, the flow channel 192b is provided with a plurality of flow-down ports (FIG. 5) at portions thereof which are over the respective parts to be lubricated. In order that the lubrication oil is reliably supplied from a place just over each of the respective parts to be lubricated, the flow channel 192b is not limited to being linear in shape and instead, may take a shape deformed or curved to make the flow-down ports reside over the respective parts to be lubricated.

The first receiver 192 is arranged in the axial direction from a start point on the internal combustion engine E/G side as it is downwardly inclined at a predetermined angle and extends to a predetermined position like that in the first embodiment, for lubricating the gears 156, 155, 154, 153 and the input shaft shift clutches which are arranged in the vicinity of the ring gear 180 in the axial direction.

The second lubrication mechanism 200 includes the lubrication oil storage region 191 common to the first lubrication mechanism 190 and the second receiver 194. As mentioned earlier, the lubrication oil storage region 191 enables the stored lubrication oil to be scooped up by the rotation of the first-speed driven gear 161 over the first-speed driven gear 161. The lubrication oil scooped up by the first-speed driven gear 161 splashes over the first-speed driven gear 161 and is collected by the second receiver 194.

The second receiver 194 is a member which is separate from the mission case 11 and which is secured by bolt fastening to the mission case 11. As shown in FIG. 5, the second receiver 194 has a collecting portion 194a at a position which is above the first-speed driven gear 161 and which is approximately in the direction tangential to the outer circumference of the first-speed driven gear 161, for collecting the splashing lubrication oil. The second receiver 194 also has a flow channel 194b for leading the collected lubrication oil to supply the same toward toothed surfaces of the gears 152, 157 and the output shaft shift clutches being respective parts to be lubricated which are arranged in the vicinity of the first-speed driven gear 161 in the axial direction. Further, the second receiver 194 also has another flow channel 194d for leading the collected lubrication oil toward the side opposite to the flow channel 194b with the collecting portion 94a therebetween and for supplying the lubrication oil toward the interiors of the input shaft 123 and the output shaft 133. A lower end portion of the flow channel 194d is provided with a supply port 194c for supplying the lubrication oil toward the interiors of the input and output shafts 123, 113 and the like. That is, the flow channel 194b and the flow channel 194d extend downwardly respectively toward opposite sides from a center point over the first-speed driven gear 161 in the axial direction and collectively take a generally inverted V-letter shape in the side view.

The collecting portion 194a is a part for collecting the lubrication oil which splashes by being scooped up by the rotation of the first-speed driven gear 161, and is placed at a position shown in FIG. 4 which is above the first-speed driven gear 161 and which is in the direction tangential to the outer circumference of the first-speed driven gear 161, so that the most part of the splashing lubrication oil falls in the collecting portion 194a.

The flow channel 194b for supplying lubrication oil toward the toothed surfaces of the gears 152, 157 and the output shaft shift clutches extends to a position in the axial direction where it comes close to or partly overlaps a lower end portion of the first receiver 192 for the same reason as mentioned about the flow channel 94b in the foregoing first embodiment. Accordingly, the flow channel 194b may not be provided (i.e., may be omitted) if, as mentioned before regarding the flow channel 94b, the first receiver 192 is extended to the neighborhood of the first-speed driven gear 161 in the axial direction and hence, is able to sufficiently lubricate the toothed surfaces of the gears 152, 157 and the output shaft shift clutches which are arranged in the vicinity of the first-speed driven gear 161.

In order that lubrication oils of an adequate quantity are supplied to flow down or drop on the respective parts to be lubricated such as the toothed surfaces of the gears 152, 157, the output shaft shift clutches and the like, the flow channel 194b is also provided with a plurality of flow-down ports 194g at respective positions thereof being over the respective parts to be lubricated. From the point of view of reliably supplying lubrication oil from those positions right over the respective parts to be lubricated like the flow channel 192b, the flow channels 194b are not limited to being linear in shape and instead, may take a shape deformed or curved to correspond to the positions of the respective parts to be lubricated.

The supply port 194c is formed at the lower end of the flow channel 194d and is inserted into the transverse hole (not shown) which is in fluid communication with the inflow grooves 11a formed on the cover 11b of the mission case 11. The second receiver 194 sends lubrication oil from the supply port 194c to the transverse hole communicating with the inflow grooves 11a and supplies the lubrication oil to the through hole formed in the input shaft 123 through one of the inflow grooves 11a. The second receiver 194 also supplies the lubrication oil through the other inflow groove 11a to the through hole formed in the output shaft 133.

In the transmission 111 constructed as described above, during the travelling of the vehicle, lubrication oil is continuously scooped upward by the ring gear 180 being continuously rotated of the differential gear. Then, the lubrication oil so scooped up is collected in the first receiver 192 of the first lubrication mechanism 190 and is efficiently circulated within the mission case 11. Further, lubrication oil is continuously scooped upward by the first-speed driven gear 161 being continuously rotated. The lubrication oil so scooped up is collected in the second receiver 194 of the second lubrication mechanism 200 and is efficiently circulated within the mission case 11.

In this way, the scooping of lubrication oil is continuously carried out by the two large-diameter gears of the ring gear 180 and the first-speed driven gear 161 which are arranged on the opposite end sides on the output shaft 133 in the axial direction, and the lubrication within the mission case 11 is carried out, so that the same effects as the foregoing first embodiment can be accomplished.

### Third Embodiment

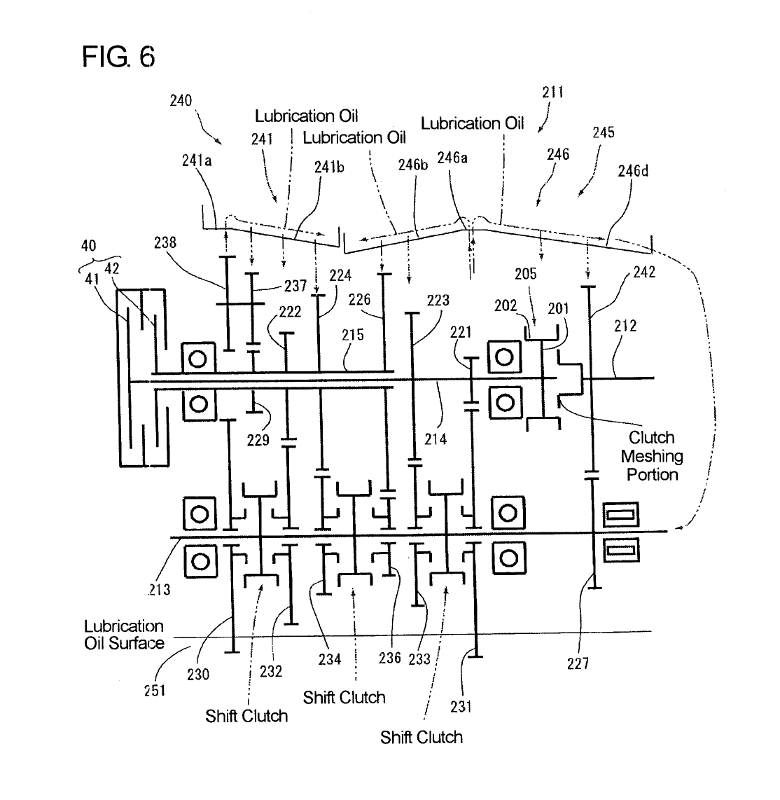

Next, a third embodiment will be described with reference to FIG. 6 being a skeletal figure. Like the transmission 1 in the foregoing first embodiment, a transmission 211 in the third embodiment is a dual-clutch automatic transmission and a six-forward speed transmission. In the transmission 1 in the first embodiment, the respective shaft members are constituted by the first and second output shafts 31, 32 which are arranged in parallel to the first and second input shafts 21, 22 arranged coaxially. On the contrary, the transmission 211 in the third embodiment constitutes respective shaft members by first and second input shafts 214, 215 which are arranged coaxially as is the case of the transmission 1, an output shaft 212 arranged in axial alignment with the input shafts 214, 215, and a counter shaft 213 arranged in parallel to the first and second input shafts 214, 215, and differs in this respect from those in the foregoing embodiments.

Another difference resides in that a first large-diameter gear arranged on one end side in the axial direction of the shaft members is the ring gear 80 in the foregoing first embodiment, but is a reverse gear 230 supported on the counter shaft 213 in the third embodiment. With this difference, there is also provided another difference in the arrangement of gears, and therefore, the following description will be made regarding those respects differing from the first embodiment, whereas description regarding the same parts will be omitted.

As shown in FIG. 6, the transmission 211 is a dual-clutch automatic transmission and is provided in the case (not shown) with the first input shaft 214, the second input shaft 215, the output shaft 212 and the counter shaft 13 all constituting the shaft members.

The case is provided therein with the dual clutch 40, drive gears 221-224, 226 (corresponding to the “drive gears” in the claimed invention) for respective speed change stages, driven gears 231-234, 236 (corresponding to the “driven gears” in the claimed invention) for the respective speed change stages, the reverse gear 230, an output shaft reduction gear 227, a reduction driven gear 242, a first lubrication mechanism 240 and a second lubrication mechanism 245. The reverse gear 230 corresponds to the “first large-diameter gear” in the claimed invention, whereas the first-speed driven gear 231 corresponds to the “second large-diameter gear” in the claimed invention.

A first-speed drive gear 221 and a third-speed drive gear 223 are formed on the first input shaft 214. A hub 201 of a shift clutch 205 is press-fitted through spline fitting on an end portion of the first input shaft 214 which end portion is on the opposite side (corresponding to “the other end side” in the claimed invention) to an internal combustion engine E/G (not shown) side in the axial direction. The shift clutch 205 is selectively connectable with a clutch meshing portion which is formed on the output shaft 212 arranged in axial alignment with the first input shaft 214 and is brought into rotational connection (direct connection) for a fifth-speed stage.

A second-speed drive gear 222, a fourth-speed drive gear 224, a sixth-speed drive gear 226 and a small-diameter gear 229 are formed on the second input shaft 215. The small-diameter gear 229 is always in rotational connection with the reverse gear 230 supported on the counter shaft 213 through a first counter gear 237 and a second counter gear 238.

The output shaft 212 is provided at its front end with a portion for meshing with the shift clutch 205 and is also provided with the reduction driven gear 242 formed at its center portion. The reduction driven gear 242 is always in rotational connection with the output shaft reduction gear 227 which is formed on the other end side of the counter shaft 213 in the axial direction. The rear end of the output shaft 212 is connected to a wheel shaft for driving rear wheels of the vehicle.

The counter shaft 213 rotatably supports the first-speed driven gear 231, a second-speed driven gear 232, a third-speed driven gear 233, a fourth-speed driven gear 234, a sixth-speed driven gear 236 and the reverse gear 230 to be able to idle on support portions formed on the outer surface thereof. The output shaft reduction gear 227 is formed on the outer surface of the counter shaft 213. The first-speed driven gear 231 is arranged together with the output shaft reduction gear 227 on the counter shaft 231 on the opposite side (corresponding to “the other end side” in the claimed invention) to the internal combustion engine E/G side in the axial direction. In the present embodiment, the first-speed driven gear 231 constitutes a second large-diameter gear.

While either one of the first and second input shafts 214, 215 is rotated during the travelling of the vehicle, either one of the drive gears on such one input shaft 214 or 215 is brought into rotational connection with either one of the driven gears supported on the counter shaft 213, so that the counter shaft 213 is continuously rotated. Thus, the rotation is coupled to the reduction driven gear 242 through the output shaft reduction gear 227 formed on the counter shaft 213, whereby the driving power is outputted form the output shaft 212. In the case of the fifth-speed stage, the speed stage is set through the direction connection of the first input shaft 214 with the output shaft 212, whereby the driving power is outputted form the output shaft 212. At this time, the counter shaft 213 is rotated as a result that the reduction driven gear 242 of the output shaft 212 is rotated to rotate the output shaft reduction gear 227 meshing therewith.

The reverse gear 230 being the first large-diameter gear is arranged on the counter shaft 213 on the internal combustion engine E/G side (corresponding to the “one end side” in the claimed invention) in the axial direction. As mentioned earlier, the reverse gear 230 is always in rotational connection with the small-diameter gear 229 formed on the second input shaft 215, through the second counter gear 238 and the first counter gear 237. While the second input shaft 215 is not rotated, the reverse gear 230 is rotated to follow the rotation of the counter shaft 213 which is always rotated during the travelling of the vehicle as it slips or slides on the counter shaft 213. Thus, the reverse gear 230 is continuously rotated during the travelling of the vehicle. The reverse gear 230 is large in diameter and, by being soaked at its lower part in the lubrication oil in the lubrication oil storage region 251, is able to continuously scoop the lubrication oil upward.

The first-speed driven gear 231 being the second large-diameter gear meshes with the first-speed drive gear 221 formed on the first input shaft 214. Thus, the first-speed driven gear 231 is continuously rotated while the first input shaft 214 is rotated. While the first input shaft 214 is not rotated, the first-speed driven gear 231 is rotated to follow the rotation of the counter shaft 213 which, as mentioned before, is continuously rotated during the travelling of the vehicle, as it slips or slides on the counter shaft 213. That is, the first-speed driven gear 231 is continuously rotated during the travelling of the vehicle. The first-speed driven gear 231 is larger in diameter than all of other gears. The lower part of the first-speed driven gear 231 is soaked in the lubrication oil in the lubrication oil storage region 251 at the bottom portion of the mission case and is able to scoop up the lubrication oil continuously. In this way, the reverse gear 230 and the first-speed driven gear 231 being respectively the first and second large-diameter gears are held to be partly soaked in the lubrication oil in the lubrication oil storage region 251. On the other hand, the gears 232-234, 236 227 on the counter shaft 213 expect for the reverse gear 230 and the first-speed driven gear 231 are formed to be small diameters not to be soaked in the lubrication oil in the lubrication oil storage region 251. In a modified form, as mentioned in the foregoing first and second embodiments, the diameters of the gears 232-234, 236 227 expect for the reverse gear 230 and the first-speed driven gear 231 being respectively the first and second large-diameter gears may be set to such diameters that allow parts of those gears to be soaked slightly in the lubrication oil in the lubrication oil storage region 251 so that they hardly agitate the lubrication oil.

The first lubrication mechanism 240 is the same in construction and function as the first lubrication mechanism 90 in the foregoing first embodiment and comprises the lubrication oil storage region 251 and a first receiver 241. As shown in FIG. 6, the first receiver 241 includes a collecting portion 241a (corresponding to the collecting portion 92 in the first embodiment) which is provided on the internal combustion engine E/G side in the axial direction for receiving (collecting) lubrication oil, and a flow channel 241b (corresponding to the flow channel 92b in the first embodiment) for leading the collected lubrication oil toward respective parts to be lubricated.

The flow channel 241b extends in the axial direction and leads the lubrication oil scooped up by the reverse gear 230 and collected in the collecting portion 241a to supply the lubrication oil to the respective parts to be lubricated such as the toothed surfaces of the gears 222, 224, 237 and the shift clutches on the counter shaft 213 which are arranged in the vicinity of the reverse gear 230 in the axial direction. In order that lubrication oils of an appropriate quantity are supplied by being flown down or dropping toward the respective parts to be lubricated, the flow channel 241b is provided with a plurality of flow-down ports (not shown) at portions thereof which are right over the respective parts to be lubricated. The first receiver 241 is arranged in the axial direction from a start point on the internal combustion engine E/G side as it is downwardly inclined at a predetermined angle, and extends to a predetermined position like that in the first embodiment.

The second lubrication mechanism 245 includes the lubrication oil storage region 251 common to the first lubrication mechanism 240 and the second receiver 246. The lubrication oil storage region 251 enables the stored lubrication oil to be scooped up by the rotation of the first-speed driven gear 231 over the first-speed driven gear 231. The lubrication oil scooped up by the first-speed driven gear 231 splashes over the first-speed driven gear 231 and is collected by the second receiver 246.

As shown in FIG. 6, the second receiver 246 has a collecting portion 246a at a position which is above the first-speed driven gear 231 and which is in the direction tangential to the outer circumference of the first-speed driven gear 231, for collecting the splashing lubrication oil. The second receiver 246 also has a flow channel 246b for leading the lubrication oil scooped up by the first-speed driven gear 231 and collected therein and for supplying the lubrication oil toward respective parts to be lubricated such as toothed surfaces of the gears 223, 226 and the shift clutch (not numbered on the counter shaft 213) which are arranged in the vicinity of the first-speed driven gear 231 in the axial direction. Further, the second receiver 246 also has another flow channel 246d for leading the collected lubrication oil toward the side opposite to the flow channel 246b and for supplying the lubrication oil toward the toothed surface of the reduction driven gear 242 and the shift clutch 205 which are arranged behind the first-speed driven gear 231 in the axial direction, as well as toward the interior of the counter shaft 213.

A lower end portion of the flow channel 246d is provided with a supply port (not shown) for supplying the lubrication oil toward the interior of the counter shaft 213 and the like. The flow channel 246b and the flow channel 246d extend downwardly respectively toward opposite sides from a center point over the first-speed driven gear 231 in the axial direction and collectively take a generally inverted V-letter shape in the side view.

The collecting portion 246a of the second receiver 246 is a part for collecting the lubrication oil which splashes by being scooped up by the rotation of the first-speed driven gear 231 and is placed at a position which is above (or partly over) the first-speed driven gear 231 and which in the direction tangential to the outer circumference of the first-speed driven gear 231 so that the most part of the splashing lubrication oil scooped by the first-speed driven gear 231 falls in the collecting portion 246a.

The flow channel 246b extends to a position in the axial direction where it comes close to or partly overlaps a lower end portion of the flow channel 241b of the first receiver 241. The flow channel 246b is for lubricating the toothed surfaces of the gears 223, 226 and the shift clutch (not numbered on the counter shaft 213) which are not lubricated by the first receiver 24. Accordingly, the flow channel 246b may not be provided (i.e., may be omitted) if the first receiver 241 is extended to the neighborhood of the first-speed driven gear 231 and hence, is able to sufficiently lubricate the toothed surfaces of the gears 223, 226 and the shift clutch (not numbered on the counter shaft 213) which are arranged in the vicinity of the first-speed driven gear 231.

In order that lubrication oils of an adequate quantity are supplied to flow down or drop on the respective parts to be lubricated such as the toothed surfaces of the gears 223, 226, the shift clutch (not numbered on the counter shaft 213) and the like, the flow channel 246b is also provided with a plurality of flow-down ports (not shown) at respective positions thereof being over the respective parts to be lubricated.

The supply port (not shown) formed at an end of the flow channel 246d is inserted into a transverse hole (not shown) which is in fluid communication with an inflow groove (not shown) formed on the cover of the mission case, in the same manner as described in the foregoing first embodiment. The second receiver 246 leads lubrication oil from the supply port to the transverse hole communicating with the inflow groove and supplies the lubrication oil through the inflow groove to a through hole (not shown) formed in the counter shaft 213, so that the lubrication oil in the counter shaft 213 are supplied to the support portions on the counter shaft 213 for the gears rotatably supported thereon, through radial passages (not shown) opening on the support portions. Therefore, the same effects as those in the foregoing first and second embodiments can be attained also in the aforementioned construction.

In each of the foregoing first to third embodiments, the flow channel 92b, 192b, 241b of the first receiver 92, 192, 241 and the flow channel 94b, 194b, 246b of the second receiver 94, 194, 246 are configured to extend to respective positions where they come close to each other respectively from one end side and the other end side or to a position where they slightly overlaps each other so that the two receivers can cover the toothed surfaces of almost all of the gears and almost all of the shift clutches which are to be lubricated. However, the present invention is not limited to such arrangement of the two receivers. In a modified form, two of the first and second receivers may be arranged to extend respectively from one end side toward the other end side and from the other end side toward one end side as they cross with each other in an X-letter fashion. The same effects can also be attained in this modified form.

Various features and many of the attendant advantages in the foregoing embodiments will be summarized as follows:

In each of the foregoing first to third embodiments as typically shown in FIGS. 2, 5 and 6, the first and second large-diameter gears 80, 61, 180, 161, 230, 231 are arranged respectively at axial opposite ends of the plurality of gears in the transmission 1, 111, 211. The first and second large-diameter gears 80, 61, 180, 161, 230, 231 are soaked at the lower parts in the lubrication oil in the lubrication oil storage region 91, 191, 251 and operate to scoop up the lubrication oil during rotations. The lubrication oils scooped up by the first and second large-diameter gears 80, 61, 180, 161, 230, 231 are respectively collected by the first and second receivers 92, 94, 192, 194, 241, 246 and are supplied to the respective parts to be lubricated. In this way, the scooping the lubrication oil is performed by each of the two large-diameter gears 80, 61, 180, 161, 230, 231, whereas other gears except for the first and second large-diameter gears 80, 61, 180, 161, 230, 231 hardly agitate the lubrication oil in the lubrication oil storage region 91, 191, 251. Thus, the total resistance acting on the plurality of gears can be decreased, so that the power transmission efficiency can be enhanced. Further, since the two large-diameter gears 80, 61, 180, 161, 230, 231 only are required to be partly soaked in the lubrication oil in lubrication oil storage region 91, 191, 251, the quantity of the lubrication oil stored in the lubrication oil storage region 91, 191, 251 can be reduced, so that the reductions in cost as well as weight can be realized.

In each of the foregoing first to third embodiments as typically shown in FIGS. 2, 5 and 6, the first and second large-diameter gears 80, 61, 180, 161, 230, 231 are continuously rotated during the travelling of the vehicle. Thus, during the travelling of the vehicle, the lubrication oil is continuously scooped up by the two large-diameter gears 80, 61, 180, 161, 230, 231 without being stopped from being scooped up. Therefore, lubrication oil is reliably supplied to the parts to be lubricated such as the toothed surfaces of other speed change gears and the interiors of the shaft members (e.g., 31, 32, 123, 133, 213), so that lack of lubrication oil at the parts to be lubricated does not take place.

In each of the foregoing first to third embodiments as typically shown in FIGS. 2, 5 and 6, the lubrication oil collected by the first receiver 92, 192, 241 is supplied to the toothed surfaces of the gears and shift clutches which are arranged in the vicinity of the first large-diameter gear 80, 180, 230 of the parts to be lubricated. Further, the lubrication oil collected by the second receiver 94, 194, 246 is supplied to the toothed surfaces of the gears and the shift clutches which are arranged in the vicinity of the second large-diameter gear 61, 161, 231 of the parts to be lubricated, as well as to the support portions for the respective gears on the shaft members (e.g., 31, 32, 123, 133, 213) through the interiors of the same. In this way, the two receivers 92, 192, 241 and 94, 194, 246 share the parts to be lubricated, so that it is possible in a simplified construction to efficiently supply lubrication oil to almost all of the parts to be lubricated.

In each of the foregoing first embodiment typically shown in FIGS. 1 and 3, the transmission 1 is configured as a dual-clutch automatic transmission. In the transmission of this type, it is often the case that when one input shaft 21 (22) is coupled by the clutch 41 (42) to the internal combustion engine E/G, the other input shaft 22 (21) is not drivingly rotated. However, either one of the output shafts 31, 32 is drivingly rotated by either one of the input shafts 21, 22 during the travelling of the vehicle. In such a dual-clutch automatic transmission, the ring gear 80 of the differential gear which is always in driving connection with the first output shaft 31 and the second output shaft 32 is utilized as the first large-diameter gear for scooping up lubrication oil, so that lubrication oil is continuously scooped up during the travelling of the vehicle. Further, because of being chosen as the first-speed driven gear 61 which is supported on the first output gear 31 in driving connection with the first input shaft 21, the second large-diameter gear 61 is drivingly rotated by the rotation of the first input shaft 21 and, while the first input shaft 21 is not rotated, is continuously rotated by the first output shaft 31 to follow the same. Consequently, during the travelling, the lubrication oil is continuously scooped up by the first and second large-diameter gears 80, 61, so that the lubrication capability of the transmission 1 can be enhanced. In addition, the ring gear 80 of the differential gear is constituted as a final gear which is large in reduction ratio in the transmission 1, and the first-speed driven gear 61 is also constituted as a gear which is large in reduction ratio. Thus, the agitation resistance acting on the ring gear 80 is transmitted to the internal combustion engine E/G being a prime mover through a gear or gears which have a reduction ratio depending on the shift position. Further, the agitation resistant acting on the first-speed driven gear 61 is transmitted to the internal combustion engine E/G through the first-speed drive gear 51. Therefore, the forces which the agitation resistances acting on the two large-diameter gears 80, 61 exert on the internal combustion engine E/G are small, so that it is possible to reduce the resistance against the engine driving power.

In each of the foregoing first to third embodiments typically shown in FIGS. 1 and 4, the first and second receivers 92, 94, 192, 194, 241, 246 are provided with collecting portions 92a, 94a, 192a, 194a, 241a, 246a at respective positions which are located above or partly over the plurality of gears and in the respective directions tangential to outer circumferences of the first and second large-diameter gears 80, 61, 180, 161, 230, 231 for receiving the lubrication oils which fall down after being scooped and splashed by the first and second large-diameter gears 80, 61, 180, 161, 230, 231. Therefore, it is possible to efficiently collect the lubrication oils scooped upward and splashed by the first and second large-diameter gears 80, 61, 180, 161, 230, 231 and to supply the collected lubrication oil to the parts to be lubricated by utilization of gravity of the collected lubrication oil.

In each of the foregoing first and second embodiments as typically shown in FIGS. 1 and 4, the separator 93, 193 surrounding a circumferential part of a larger one of the first and second large-diameter gears 80, 180 is provided for partitioning the part surround by the separator 93, 193 of the lubrication oil storage region 91, 191 from the remaining part of the lubrication oil storage region 91, 191. Therefore, it is possible to stabilize the quantity and splashing direction of the lubrication oil scooped up by the rotation of the larger one of the first and second large-diameter gears 80, 180 and to reduce the agitation of the lubrication oil in the lubrication oil storage region 91, 191.

Obviously, further numerous modifications and variations of the present invention are possible in light of the above teachings. It is therefore to be understood that within the scope of the appended claims, the present invention may be practiced otherwise than as specifically described herein.

What is claimed is:

1. A transmission for a vehicle, comprising:
a case;
at least one shaft member rotatably supported in the case to extend in an axial direction;
a plurality of gears rotatably supported on the at least one shaft member and rotationally connectable by shift clutches with the at least one shaft member;
first and second large-diameter gears included in the plurality of gears and soaked at lower parts thereof in lubrication oil stored in a lubrication oil storage region which is formed at a lower portion in the case, for scooping upward the lubrication oil during rotations; and
first and second receivers arranged to extend in the axial direction of the at least one shaft member for respectively collecting lubrication oils scooped upward by the first and second large-diameter gears and for supplying the collected lubrication oils toward parts to be lubricated;
wherein the first and the second large-diameter gears are arranged respectively on one end side and the other end side in the axial direction of the plurality of gears; and
wherein the gears except for the first and second large-diameter gears are formed to have respective diameters which hardly agitate the lubrication oil stored in the lubrication oil storage region.

2. The transmission for a vehicle as set forth in claim 1, wherein:
the first and second large-diameter gears are gears which are continuously rotated during the travelling of the vehicle.

3. The transmission for a vehicle as set forth in claim 2, wherein:
the parts to be lubricated include the plurality of gears and the shift clutches;
the first receiver is configured to supply the collected lubrication oil toward toothed surfaces of gears arranged in the vicinity of the first large-diameter gear of the plurality of gears and toward shift clutches arranged in the vicinity of the first large-diameter gear of the shift clutches; and
the second receiver is configured to supply the collected lubrication oil toward toothed surfaces of gears arranged in the vicinity of the second large-diameter gear of the plurality of gears, toward shift clutches arranged in the vicinity of the second large-diameter gear of the shift clutches and to the interior of the at least one shaft member.

4. The transmission for a vehicle as set forth in claim 3, wherein the transmission is a dual clutch transmission which includes:
as the at least one shaft member, first and second input shafts coaxially rotatably supported in the case and coaxially arranging thereon drive gears of the plurality of gears and first and second output shafts rotatably supported in the case and respectively rotatably supporting thereon driven gears of the plurality of gears; and
a dual clutch comprising a first clutch for transmitting the driving power form a prime mover to the first input shaft and a second clutch for transmitting the driving power to the second input shaft; and wherein:
the first large-diameter gear is a ring gear of a differential gear which is always drivingly connected to the first and the second output shafts; and
the second large-diameter gear is a first-speed driven gear rotatably supported on the first output shaft and drivingly connected to the first input shaft.

5. The transmission for a vehicle as set forth in claim 1, wherein the first and second receivers are provided with collecting portions at respective positions which are located above the plurality of gears and in respective directions tangential to outer circumferences of the first and second large-diameter gears for receiving the lubrication oils falling down by being scooped and splashed by the first and second large-diameter gears.

6. The transmission for a vehicle as set forth in claim 1, further comprising:
a separator surrounding a circumferential part of a larger one of the first and second large-diameter gears for partitioning a part surround by the separator of the lubrication oil storage region from the remaining part of the lubrication oil storage region.
